(19) United States
(12) Patent Application Publication
(10) Pub. No.: US 2008/0018580 A1
(43) Pub. Date: Jan. 24, 2008

(54) Apparatus for driving a display device and method therefor

(75) Inventor: Yu-Pin Chou, Tongsiao Township (TW)

Correspondence Address: RABIN & Berdo, PC, 1101 14TH STREET, NW, SUITE 500, WASHINGTON, DC, 20005, US

(73) Assignee: REALTEK SEMICONDUCTOR CORP., Hsinchu (TW)

(21) Appl. No.: 11/602,312

(22) Filed: Nov. 21, 2006

(30) Foreign Application Priority Data
Jul. 20, 2006 (TW) 95126473

(51) Int. Cl. G09G 3/36

(52) U.S. Cl. 345/98

(57) ABSTRACT

Apparatus for driving a display device and method therefor. The apparatus is used for controlling the display device to display video frames according to a video signal. The apparatus includes a controller, a first driving circuit, and a second driving circuit. The controller is used for generating a first control signal and a second control signal according to the video signal. The first driving circuit, including m first driving devices, is used for enabling the display device, according to the first control signal, to display a portion of a video frame corresponding to the video signal. The second driving circuit, including n second driving devices, is used for enabling the display device, according to the second control signal, to display a portion of the video frame corresponding to the video signal, wherein m and n are two different positive integers.

This application claims the benefit of Taiwan application Serial No. 95126473, filed Jul. 20, 2006, the subject matter of which is incorporated herein by reference.

### BACKGROUND OF THE INVENTION

1. Field of the Invention

The invention relates in general to an apparatus for driving a display device, and more particularly to an apparatus including a number of first driving devices and a different number of second driving devices, according to two control signals, respectively for driving two regions of a display device.

2. Description of the Related Art

As shown in FIG. 1, a conventional liquid crystal display 50 employs a display driving approach in a front-back mode. In this mode, the implementation of this driving approach is symmetrical, using two driving circuits 3 each having an equal number of source drivers 30 to display two halves 51 and 52 of a video frame of the liquid crystal display 50. For instance, if the liquid crystal display 50 has a horizontal resolution of 1280, that is, a horizontal scan line having 1280 pixels, the implementation for this mode is to apply one driving circuit 3 having n source drivers 30 to display 640 pixels corresponding to a horizontal scan line and to apply another driving circuit 3 that has n source drivers 30 to display the remaining 640 pixels corresponding to the horizontal scan line. Since it is insufficient to display 640 pixels by using n−1 source drivers 30, each driving circuit 3 at least has n source drivers 30. Unfortunately, such implementation may lead to a portion of hardware resource being idle because the n source drivers 30, as fully applied, are capable of driving over 640 pixels. For example, as 2n−1 source drivers 30 are sufficient to drive 1280 pixels corresponding the horizontal scan line, the 2n source drivers 30 employed in the conventional implementation as above would result in one source driver 30 being idle substantially, thus wasting the performance and hardware cost of one source driver.

### SUMMARY OF THE INVENTION

It is therefore an object of the invention to provide an apparatus for driving a display device and a method therefor, to use hardware resource efficiently.

According to an embodiment of the invention, an apparatus for driving a display device is provided. The apparatus is used for controlling the display device to display video frames according to a video signal. The apparatus includes a controller, a first driving circuit, and a second driving circuit. The controller is used for generating a first control signal and a second control signal according to the video signal. The first driving circuit, including m first driving devices, is used for enabling the display device, according to the first control signal, to display a portion of a video frame corresponding to the video signal. The second driving circuit, including n second driving devices, is used for enabling the display device, according to the second control signal, to display a portion of the video frame corresponding to the video signal, wherein m and n are two different positive integers.

According to another embodiment of the invention, a method for driving a display device is provided. The method is used for controlling the display device to display video frames according to a video signal. The method the following steps. A first control signal and a second control signal are generated according to the video signal. Next, according to the first control signal, the display device is enabled to display p pixels corresponding to the video signal. According to the second control signal, the display device is enabled to display q pixels corresponding to the video signal, wherein p and q are two different positive integers.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) illustrates a conventional display driving approach in a front-back mode.

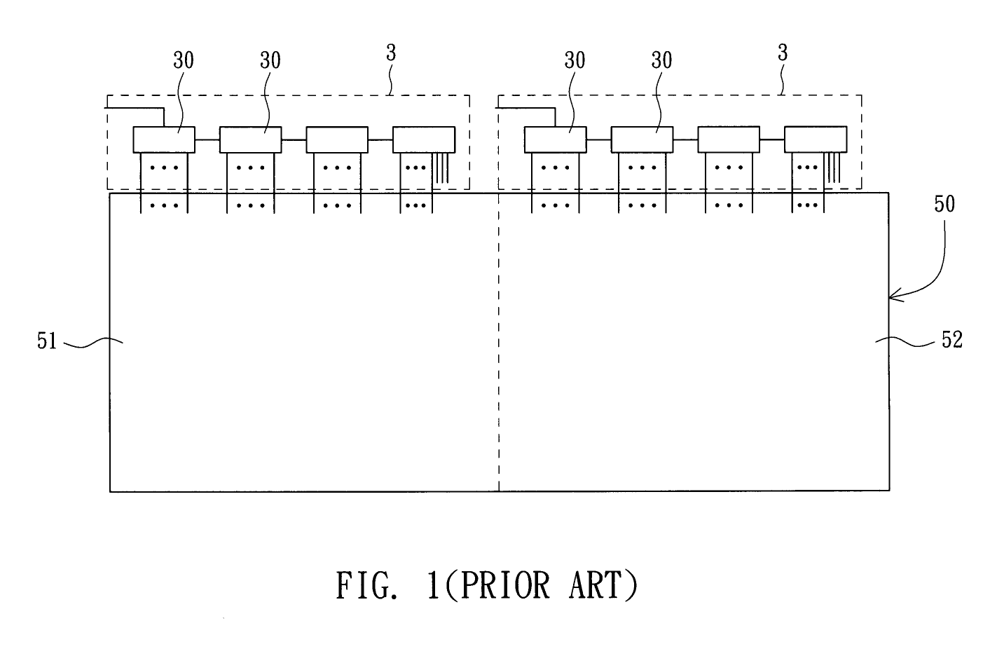

FIG. 2 illustrates an example of driving a display panel using a driving apparatus according to an embodiment of the invention, with a driving device not fully utilized.

FIG. 3 illustrates an example of driving a display panel using a driving apparatus according to an embodiment of the invention, with all driving devices fully utilized.

### DETAILED DESCRIPTION OF THE INVENTION

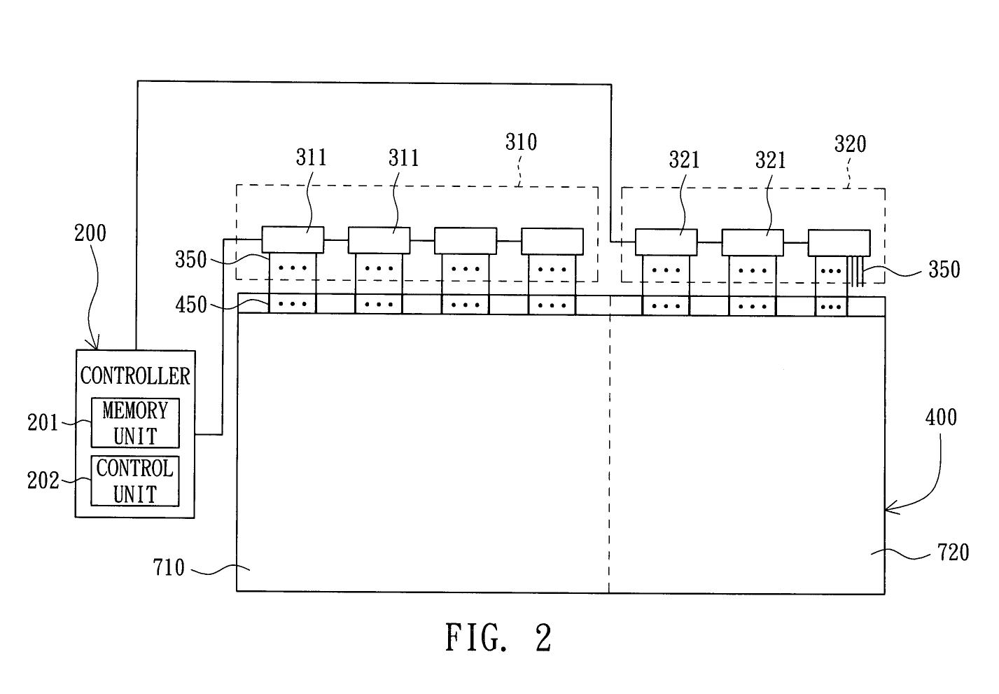

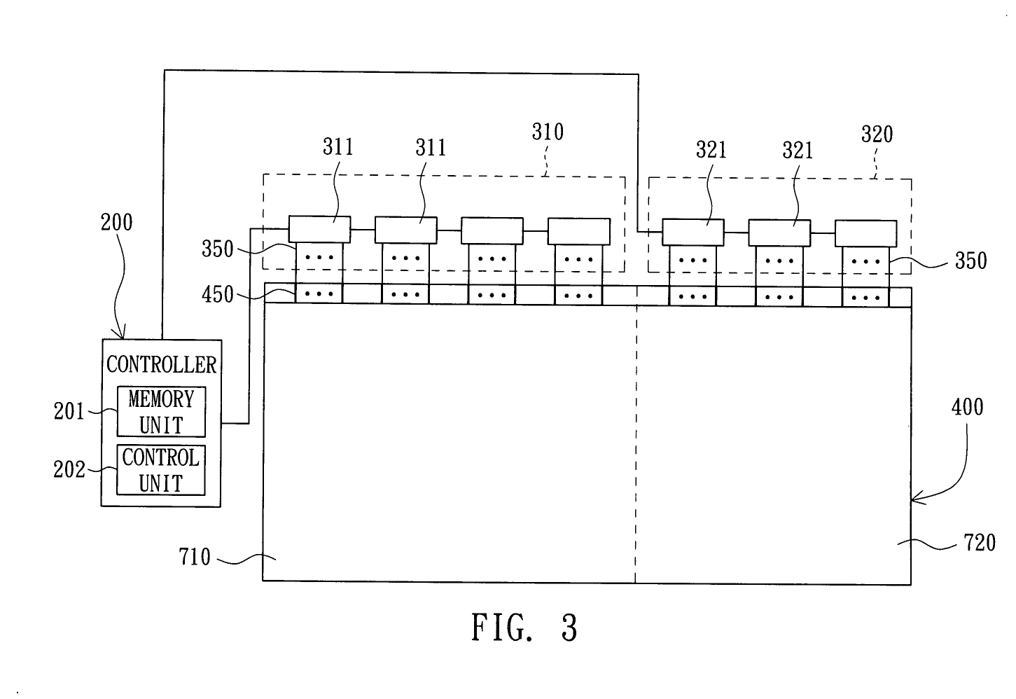

According to an embodiment of the invention, FIGS. 2 and 3 illustrate an apparatus for driving a display device, such as a liquid crystal display, for controlling the display device to display video frames according to a video signal. The driving apparatus includes a controller 200, a first driving circuit 310, and a second driving circuit 320. The controller 200, coupled to the first driving circuit 310 and second driving circuit 320, for generating a first control signal and a second control signal according to the video signal. The first control signal and second control signal are outputted to the first driving circuit 310 and second driving circuit 320 respectively. The first driving circuit 310 is used for enabling the display device, according to the first control signal, to display a portion of a video frame corresponding to the video signal. The second driving circuit 320 is used for enabling the display device, according to the second control signal, to display a portion of the video frame corresponding to the video signal. For example, the first driving circuit 310 enables the display device to display p pixels corresponding to a horizontal scan line while the second driving circuit 320 enables the display device to display q pixels corresponding to the horizontal scan line, wherein p and q are two different positive integers. In this embodiment, the sum of p and q is equal to the total number of pixels that the horizontal scan line corresponds to In addition, the controller 200 includes a memory unit 201 and a control unit 202. The memory unit 201, coupled to the control unit 202, is used for storing parameter data, which may be adjustable and indicates one or more parameters, such as p, q, or a resolution value. According to the parameter data, the first driving circuit 310 and second driving circuit 320 can drive the display device to display a group of p pixels and a group of q pixels, respectively. In one embodiment, the parameter data represents the value of q and a value corresponding to the resolution of the display device. The control unit 202 is employed to generate the first control signal and the second control signal according to the parameter data and the video signal. Correspondingly, according to the parameter data, a video signal corresponding to the p pixels is outputted to the first driving circuit 310, and a video signal corresponding to the q pixels is outputted to the second driving circuit 320. Please note that the controller 200 could function as a traditional controller if the parameter data stored in the memory unit 201 indicates that the value of p is the same as the value of q.

In the above embodiment, the video signal is compliant with RSDS (Reduced Swing Differential Signaling) type III. In another embodiment, the video signal can be applied in a different signal format, such as TTL (Transistor-Transistor Level), TTL/TCON (Transistor-Transistor Level/Timing Control), or LVDS (Low Voltage Differential Signal). In this regard, one of ordinary skill in the art would be able to apply a signal format such as the one mentioned above or other ones in implementation according to the disclosure of the invention.

The first driving circuit 310 includes a number of first driving devices 311, for example, a number of source driver integrated circuits. Each of the first driving devices 311 has a number of output channels 350. Each of the first driving devices 311 is for driving the display to display a portion of a video frame corresponding to the video signal according to the first control signal. The second driving circuit 320 includes a number of second driving devices 321, for example, a number of source driver integrated circuits. Each of the second driving devices 321 has a number of output channels 350. Each of the second driving devices 321 is for driving the display to display a portion of a video frame corresponding to the video signal according to the second control signal.

In addition, the display includes a display panel 400, such as a liquid crystal display panel. The display panel 400 includes a number of input channels 450 for receiving output signals from the first driving circuit 310 and second driving circuit 320 so as to display video frames corresponding to the video signal. All of the output channels 350 of each first driving device 311 of the first driving circuit 310 are coupled to a portion of the input channels 450 so that all of the output channels 350 of the first driving circuit 310 are fully employed with no output channel of the first driving circuit 310 left idle. Besides, each second driving device 321 of the second driving circuit 320 is coupled to another portion of the input channels 450 so that either all of the output channels 350 from the second driving circuit 320 are fully employed with no output channel of the second driving circuit 320 left idle, as illustrated in FIG. 3, or some output channels 350 of one second driving device 321 may be left idle or employed to transmit dummy data, as illustrated in FIG. 2.

On receiving a video signal, for example a signal or a set of signals indicating consecutive video frames, such as an analog RGB signal or digital RGB signal, the controller 200 transfers the first control signal and second control signal that are generated according to the video signal to the first driving circuit 310 and second driving circuit 320. The output channels 350 of the first driving devices 311 of the first driving circuit 310 output signals generated according to the first control signal to the corresponding input channels 450 in order to drive a first region 710 of the display panel 400 to display a portion of a video frame, according to the first control signal. The output channels 350 of the second driving devices 321 of the first driving circuit 310 output signals generated according to the second control signal to the corresponding input channels 450 in order to drive a second region 720 of the display panel 400, i.e. the remaining region, to display the other portion of the video frame, according to the second control signal.

In one embodiment, the first driving circuit 310 includes m first driving devices 311 and the second driving circuit 320 includes n second driving devices 321, where m and n are two different positive integers. As a result, the number of the output channels 350 of all of the first driving devices 311, which are coupled to a portion of the input channels 450, is different from that of the output channels 350 of all of the second driving devices 321, which are coupled to the other portion of the input channels 450. Therefore, the first region 710, driven by the first driving circuit 310, is different from the second region 720, driven by the second driving circuit 320.

In this regard, hardware resource with respect to driving circuitry can be utilized more efficiently. As an example, the display panel 400, as illustrated in FIG. 2 or 3, has a maximum resolution of 1366 by 768. That is, each horizontal scan line of the display panel 400 has 1366 pixels, and each pixel includes three sub-pixels for red, green, and blue colors, resulting in 4098 sub-pixels (1366 times 3) on each horizontal scan line. Consequently, the display panel 400 in this example has 4098 input channels 450. If the number of output channels 350 of each of the first driving devices 311 and second driving devices 321 is 384, the display panel 400 requires a number of 11 driving devices (4098/384=10.671875; the nearest whole number greater than the calculated one is taken). If the number of the first driving devices 311 is 6 and all of the output channels 350 of the first driving devices 311 are coupled to their corresponding input channels 450, the first driving devices 311 can control 2304 (6 times 384) of the input channels 450, that is, controlling 768 of the total 1366 pixels of a horizontal scan line. Thus, it is sufficient to use only 5 second driving devices 321 (1794/384=4.67; 5 is taken) to control the remaining 1794 channels (4098−2304). In the example, hardware resource is utilized more efficiently since at least one second driving device 321 is saved, as compared to the conventional driving approach in front-back mode.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An apparatus for driving a display device, for controlling the display device to display video frames according to a video signal, the apparatus comprising:
a controller for generating a first control signal and a second control signal according to the video signal;
a first driving circuit, comprising m first driving devices, for enabling the display device, according to the first control signal, to display a portion of a video frame corresponding to the video signal; and
a second driving circuit, comprising n second driving devices, for enabling the display device, according to the second control signal, to display a portion of the video frame corresponding to the video signal,
wherein m and n are two different positive integers.

2. The apparatus according to claim 1, wherein the controller comprises:
a memory unit for storing parameter data; and
a control unit for generating the first control signal and the second control signal according to the parameter data and the video signal.

3. The apparatus according to claim 2, wherein the parameter data is adjustable.

4. The apparatus according to claim 2, wherein the parameter data indicates number of pixels corresponding to at least one of the first and second driving circuits.

5. The apparatus according to claim 4, wherein the parameter data further indicates a horizontal resolution of the display device.

6. The apparatus according to claim 1, wherein the first control signal corresponds to a pixel number of p and the second control signal corresponds to a pixel number of q, where p is not equal to q.

7. The apparatus according to claim 6, wherein the sum of p and q is equal to a maximum horizontal resolution of the display device.

8. The apparatus according to claim 1, the display device is a liquid crystal display.

9. A method for driving a display device, for controlling the display device to display video frames according to a video signal, the method comprising:
generating a first control signal and a second control signal according to the video signal;
enabling the display device, according to the first control signal, to display p pixels corresponding to the video signal; and
enabling the display device, according to the second control signal, to display q pixels corresponding to the video signal,
wherein p and q are two different positive integers.

10. The method according to claim 9, further comprising:
generating the first control signal and the second control signal according to parameter data and the video signal,
wherein the parameter data indicates the value of p or q.

11. The method according to claim 10, wherein the parameter data is adjustable.

12. The method according to claim 10, wherein the parameter data further indicates a horizontal resolution of the display device.

13. The method according to claim 9, wherein the display device is a liquid crystal display.

14. The method according to claim 9, wherein the sum of p and q is equal to a maximum horizontal resolution of the display device.

15. An apparatus for driving a display device, for controlling the display device to display video frames according to a video signal, the apparatus comprising:
a memory unit for storing parameter data; and
a control unit for generating a first control signal and a second control signal according to the parameter data and the video signal, wherein the first control signal is used for controlling m first driving devices to enable the display device to display p pixels corresponding to the video signal, and the second control signal is used for controlling n second driving devices to enable the display device to display q pixels corresponding to the video signal;
wherein m, n, p, and q are positive integers; m is different from n; and q is different from q.

16. The apparatus according to claim 15, wherein the parameter data is adjustable.

17. The apparatus according to claim 15, wherein the parameter data indicates the value of p or q.

18. The apparatus according to claim 15, wherein the parameter data indicates a horizontal resolution of the display device.

19. The apparatus according to claim 15, wherein the sum of p and q is equal to a maximum horizontal resolution of the display device.
